(19) United States
(12) Patent Application Publication
(10) Pub. No.: US 2013/0009497 A1
(43) Pub. Date: Jan. 10, 2013

(54) MOTOR HOUSING WITH AN AIR-COOLING CAPABILITY

(76) Inventors: Chin-Feng Chang, Taichung City (TW); Chi-Lung Chang, Taichung City (TW); Cheng-Hui Huang, Taichung City (TW); Ming-Cheng Lin, Taichung City (TW)

(21) Appl. No.: 13/176,461

(22) Filed: Jul. 5, 2011

(51) Int. Cl. H02K 9/04; H02K 5/18

(52) U.S. Cl. 310/62; 310/64

(57) ABSTRACT

A motor housing has a heat-dissipating casing having an outer casing and an inner casing. The outer casing is tubular and has an inner surface. The inner casing is tubular, is co-axially mounted in the outer casing and has multiple fins and multiple baffle ribs. The fins are formed on and protrude radially from an outer surface of the inner casing. The baffle ribs are formed on and protrude radially from the outer surface of the inner casing and are connected to the inner surface of the outer casing to form multiple air passages between the inner surface of the outer casing and the outer surface of the inner casing. Each baffle rib has two ends and a front threaded hole and a rear threaded hole defined respectively in the ends of the baffle rib.

### BACKGROUND OF THE INVENTION

1. Field of the Invention

The present invention relates to a motor housing, and more particularly to a motor housing having an air-cooling capability to enhance the heat-dissipating capability of the motor housing.

2. Description of Related Art

A motor is substantially composed of a shaft, a rotor and a stator those are mounted in a housing. Because the motor will generate heat during the operation, multiple fins are formed around the motor housing to dissipate the heat generated by the motor and to enlarge the heat-dissipating area of the motor housing.

However, the conventional motor housing does not have an auto-cooling device, so the heat-dissipating capability of the conventional motor is not sufficient even when multiple fins are formed around the housing. Therefore, the conventional motor is easily damaged due to the heat generated by the motor itself, and the useful life of the conventional motor is shortened.

To overcome the shortcomings, the present invention tends to provide a motor housing to mitigate or obviate the aforementioned problems.

### SUMMARY OF THE INVENTION

The main objective of the invention is to provide a motor housing having an air-cooling capability to enhance the heat-dissipating capability of the motor housing.

The motor housing has a heat-dissipating casing having an outer casing and an inner casing. The outer casing is tubular and has an inner surface. The inner casing is tubular, is co-axially mounted in the outer casing and has multiple fins and multiple baffle ribs. The fins are formed on and protrude radially from an outer surface of the inner casing. The baffle ribs are formed on and protrude radially from the outer surface of the inner casing and are connected to the inner surface of the outer casing to form multiple air passages between the inner surface of the outer casing and the outer surface of the inner casing. Each baffle rib has two ends and a front threaded hole and a rear threaded hole defined respectively in the ends of the baffle rib.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a motor housing in accordance with the present invention;;

FIG. 2 is an exploded perspective view of the motor housing in FIG. 1;

FIG. 3 is another exploded perspective view of the motor housing in FIG. 1;

FIG. 4 is a side view in partial section of the motor housing in FIG. 1;

FIG. 5 is an operational side view in partial section of the motor housing in FIG. 1;

FIG. 6 is a perspective view of a second embodiment of a motor housing in accordance with the present invention;

FIG. 7 is a perspective view of a third embodiment of a motor housing in accordance with the present invention;

FIG. 8 is a side view in partial section of the motor housing in FIG. 7;

FIG. 9 is a perspective view of a fourth embodiment of a motor housing in accordance with the present invention;

FIG. 10 is another perspective view of the motor housing in FIG. 9;

FIG. 11 is an exploded perspective view of the motor housing in FIG. 9; and

FIG. 12 is a side view in partial section of the motor housing in FIG. 9.

### DETAILED DESCRIPTION OF PREFERRED EMBODIMENT

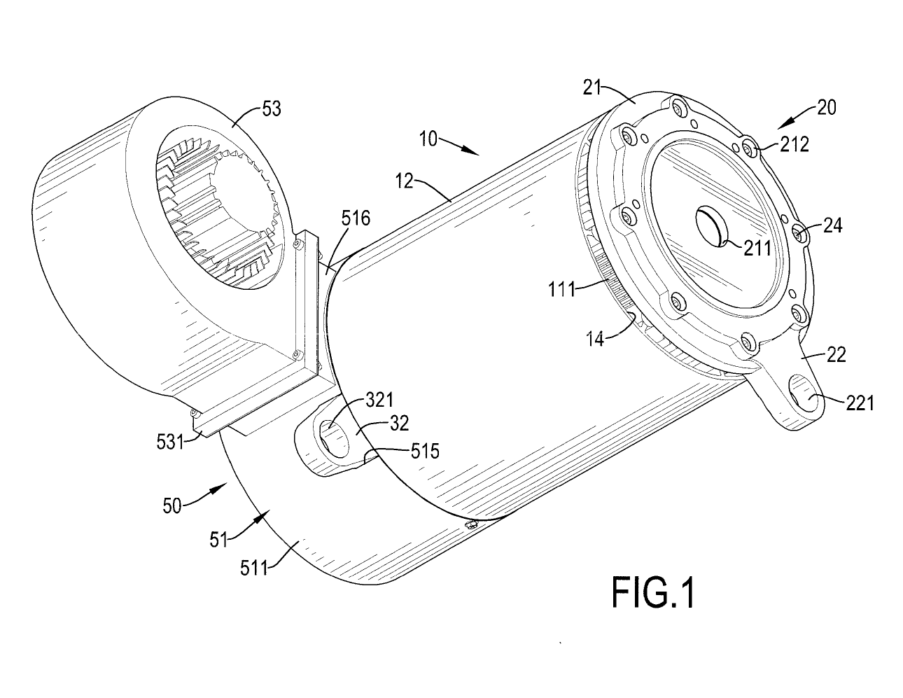

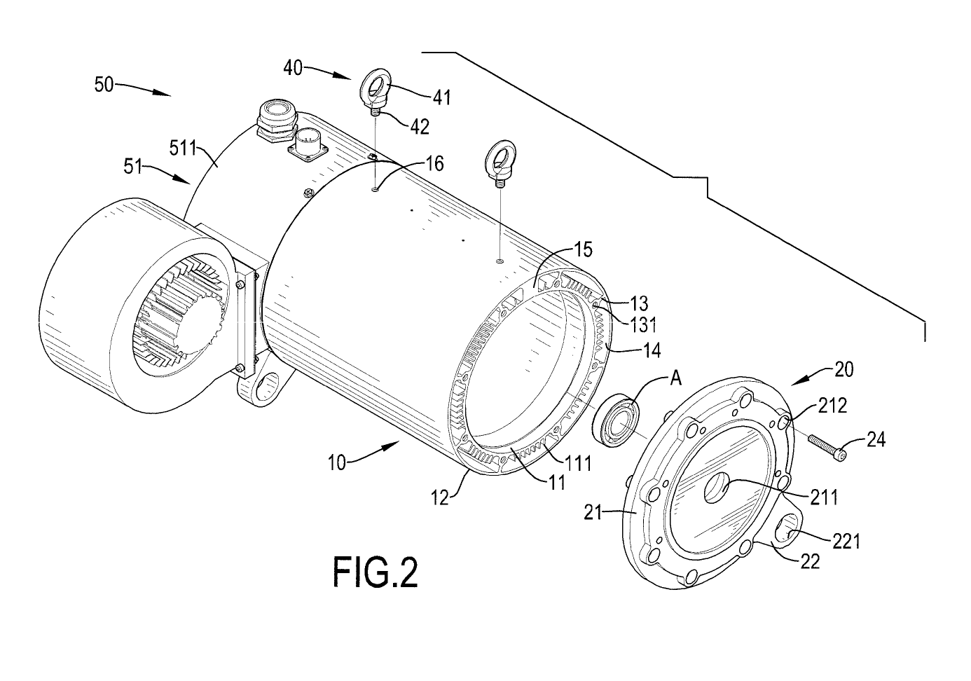

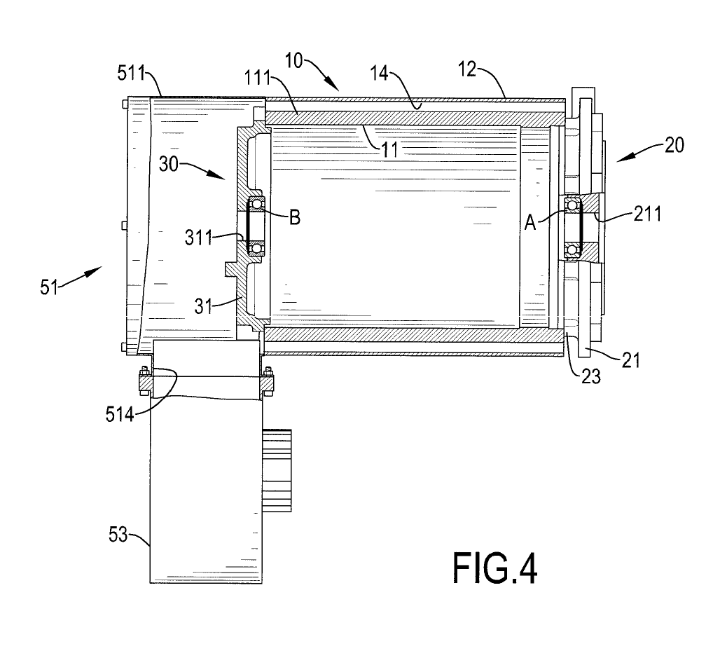

With reference to FIGS. 1 to 4, a first embodiment of a motor housing in accordance with the present invention comprises a heat-dissipating casing 10, a front cap 20, a rear cap 30 and a fan assembly 50.

The heat-dissipating casing 10 is hollow to hold a rotor, a stator and a shaft inside to form as a motor. The heat-dissipating casing 10 comprises an outer casing 12 and an inner casing 11. The outer casing 12 is tubular, may be circular in cross section and has an inner surface, an outer surface, multiple hanging holes 16 and multiple hanging rings 40. The hanging holes 16 are defined in the outer surface of the outer casing 12 and may be threaded. The hanging rings 40 are respectively connected securely to the hanging holes 16, and each hanging ring 40 has a hanging collar 41 and a threaded rod 42. The threaded rod 42 extends from the hanging collar 41 and is screwed into one of the hanging holes 16 in the outer casing 12. Accordingly, the motor housing can be hung on an object with the hanging rings 40.

The inner casing 11 is tubular, may be circular in cross section, is co-axially mounted in the outer casing 12 and has a length, an outer surface, multiple fins 111, multiple baffle ribs 13 and a securing block 15. The length of the inner casing 11 may be equal to that of the outer casing 12. The fins 111 are longitudinally formed on and protrude radially from the outer surface of the inner casing 11 to increase the heat-dissipating area of the inner casing 11. The baffle ribs 13 are longitudinally formed on and protrude radially from the outer surface of the inner casing 11 and are connected to the inner surface of the outer casing 12 to form multiple air passages 14 between the inner surface of the outer casing 12 and the outer surface of the inner casing 11. Preferably, eight baffle ribs 13 may be implemented, so that eight air passages 14 are formed. Each baffle rib 13 may have a length equal to that of the inner casing 11 and has two ends and a front threaded hole 131 and a rear threaded hole 132 defined respectively in the ends of the baffle rib 13. In addition, each baffle rib 13 has an outer side connected to the outer casing 12 and an inner side connected to the inner casing 11. The inner side of each baffle rib 13 has a width larger than that of the outer side to enable the front and rear threaded holes 131,132 defined in the inner side of the baffle rib 13. The securing block 15 is formed on and radially protrudes from the outer surface of the inner casing 11 and is connected to the inner surface of the outer casing 12. Preferably, the hanging holes 16 are defined in the outer casing 12 at positions corresponding to the securing block 15 and may extend into the securing block 15.

The front cap 20 is attached securely to the front end of the heat-dissipating casing 10 with multiple front fasteners 24 mounted through the front cap 20 and screwed respectively into the front threaded holes 131 to close the front open end of the inner casing 11. The front cap 20 may be circular and has a front panel 21, a front shaft hole 211, a front bearing A, an annular front connecting collar 23, multiple front through holes 212 and a front stand 22. The front panel 21 is round and has a diameter equal to that of the outer casing 12. The front shaft hole 211 is defined centrally through the front panel and may be countersunk. The front bearing A is mounted in the front shaft hole 211. The front connecting collar 23 is annular, is formed on the front panel 21 at a side facing the heat-dissipating casing 10 and abuts with the front open end of the inner casing 11 and the baffle ribs 13 at positions in where the front threaded holes 131 are defined to space the front panel 21 from the outer casing 12. The front through holes 212 are defined through the front panel 21 and respectively align with the front threaded holes 131 in the baffle ribs 13. The front fasteners 24 may be bolts, are mounted respectively through the front through holes 212 in the front panel 21 and are respectively screwed into the front threaded holes 131 in the baffle ribs 13 to securely connect the front cap 20 to the heat-dissipating casing 10. The front stand 22 is radially formed on and protrudes from the front panel 21 and has a front mounting hole 221 defined through the front stand 22.

The rear cap 30 is attached securely to the rear end of the heat-dissipating casing 10 with multiple rear fasteners 34 mounted through the rear cap 30 and screwed respectively into the rear threaded holes 132 to close a rear open end of the inner casing 11. The rear cap 30 may be circular and has a rear panel 31, a rear shaft hole 311, a rear bearing B, multiple rear connecting blocks 33, multiple wire holes 312 and a rear stand 32. The rear panel 31 is round and has a diameter equal to that of the inner casing 11. The rear shaft hole 311 is defined centrally through the rear panel 31 and may be countersunk. The rear bearing B is mounted in the rear shaft hole 311. The rear connecting blocks 33 are formed on and radially protrude from the periphery of the rear panel 31. Each rear connecting block 33 has a rear through hole 331 defined through the rear connecting block 33 and aligning with one of the rear threaded holes 132 in the baffle ribs 13. Preferably, each rear connecting block 33 has a free end being flush with an outer surface of the outer casing 12 and a hood connecting threaded hole 332 defined in the free end of the rear connecting block 33. The wire holes 312 are defined through the rear panel 31 around the rear shaft hole 311 at positions adjacent to the periphery of the rear panel 31. The rear fasteners 34 may be bolts, are mounted respectively through the rear through holes 331 in the rear connecting blocks 33 and are respectively screwed into the rear threaded holes 132 in the baffle ribs 13 to securely connect the rear cap 30 with the heat-dissipating casing 10. The rear stand 32 is radially formed on and protrudes from the rear panel 31 and has a rear mounting hole 321 defined through the rear stand 32. With the arrangement of the front and rear stands 22,32 on the front and rear caps 20,30, the motor housing can be securely connected to and held on a base.

The fan assembly 50 is connected to the rear end of the heat-dissipating casing 10 and comprises a wind hood 51 and an air blower 53. The wind hood 51 is connected securely with the rear end of the heat-dissipating casing 10 and communicates with the air passages 14 in the heat-dissipating casing 10. The wind hood 51 comprises a hood casing 511, multiple hood through holes 512, multiple hood fasteners 52, a rear cover 513, a vent 514, a fan connecting frame 516 and two wire tubes 54,55. The hood casing 511 is tubular, is mounted around the rear connecting blocks 33 on the rear cap 30 and has a front end abutting with the rear end of the outer casing 12 and a notch 515. The notch 515 is defined in the front end of the hood casing 511, and the rear stand 32 of the rear cap 30 is held in the notch 515. The hood through holes 512 are defined radially through the hood casing 511 and align respectively with the hood connecting threaded holes 332 in the rear connecting blocks 33 of the rear cap 30. The hood fasteners 52 may be bolts, are respectively mounted through the hood through holes 512 and are respectively screwed into the hood connecting threaded holes 332 in the rear connecting blocks 33 to securely connect the hood casing 511 with the rear cap 30. The rear cover 513 is attached to the rear end of the hood casing 511 to close the rear opening of the hood casing 511. The vent 514 is radially defined in the hood casing 511. The fan connecting frame 516 is formed on and protrude from the hood casing around the vent 514. The wires tubes 54,55 are formed on and protrude from the hood casing 511 and including a motor wire tube 54 and a fan wire tube 55.

The air blower 53 attached to the wind hood 51 to blow air into the air passages 14 via the wind hood 51 and is preferably attached to the fan connecting frame 516 on the hood casing 511.

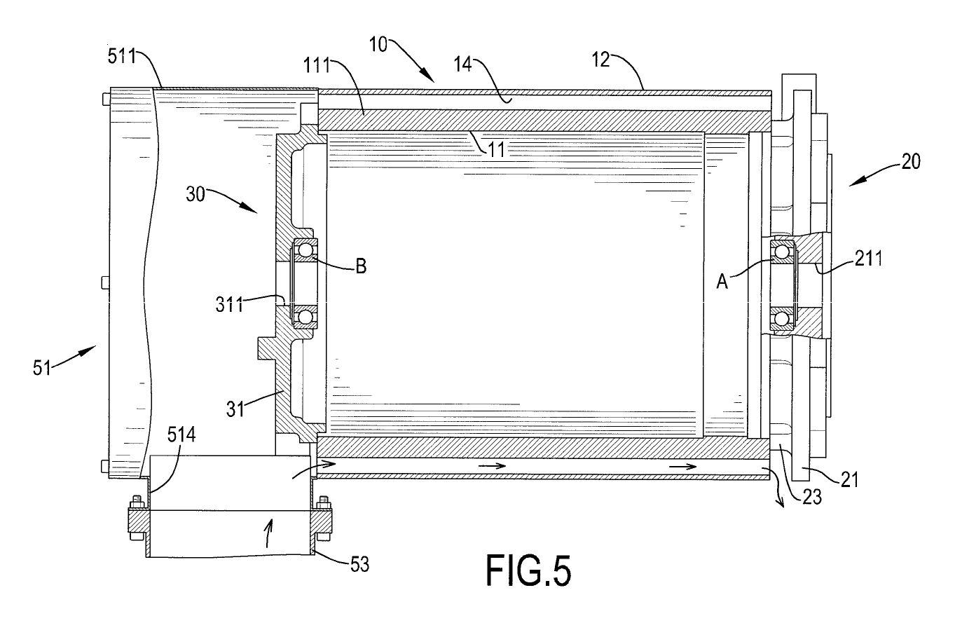

Accordingly, with reference to FIGS. 1 to 5, a rotor, a stator and a shaft are mounted in the space defined between the heat-dissipating casing 10, the front cap 20 and the rear cap 30 to form as a motor. A motor power cable extends into the heat-dissipating casing 10 and its connected to the rotor or the stator via the motor wire tube 54, the wind hood 51 and the wire holes 312 in the rear cap 30. A fan cable extends into the wind hood 51 via the fan wire tube 55 and is connected to the air blower 53 to provide a power to the air blower 53. Accordingly, the motor power cable and the fan cable can be hidden in the wind hood 51.

During the operation of the motor, the air blower 53 blows air into the air passages 14 in the heat-dissipating casing 10 via the wind hood 51. Accordingly, the heat generated during the operation, of the motor can be easily and rapidly dissipated by the air passing through the air passages 14. In addition, the fins 111 can increase the heat-dissipating area of the heat-dissipating casing 10 and the contacting area with the passing air in the air passages 14, so that the heat-dissipating effect of the motor housing can be effectively enhanced. Therefore, the temperature of the motor can be effectively reduced to prevent the motor from being damaged due to high temperature, and the useful life of the motor can be prolonged.

In addition, with the arrangement of the hanging rings 40 and the stands 22,32 on the caps 20,30, the motor can be securely held at an object, such as a base at more than three points.

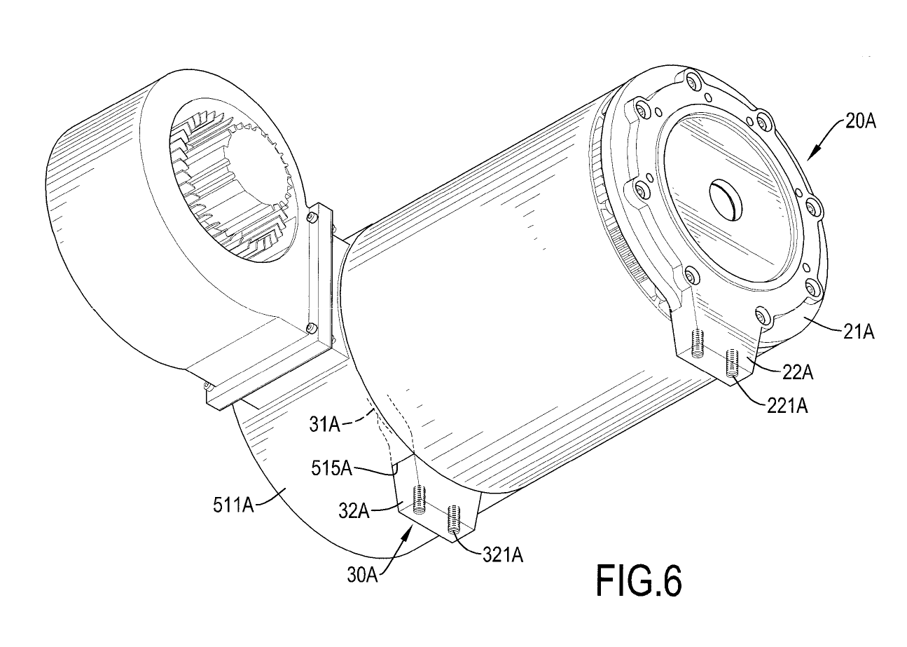

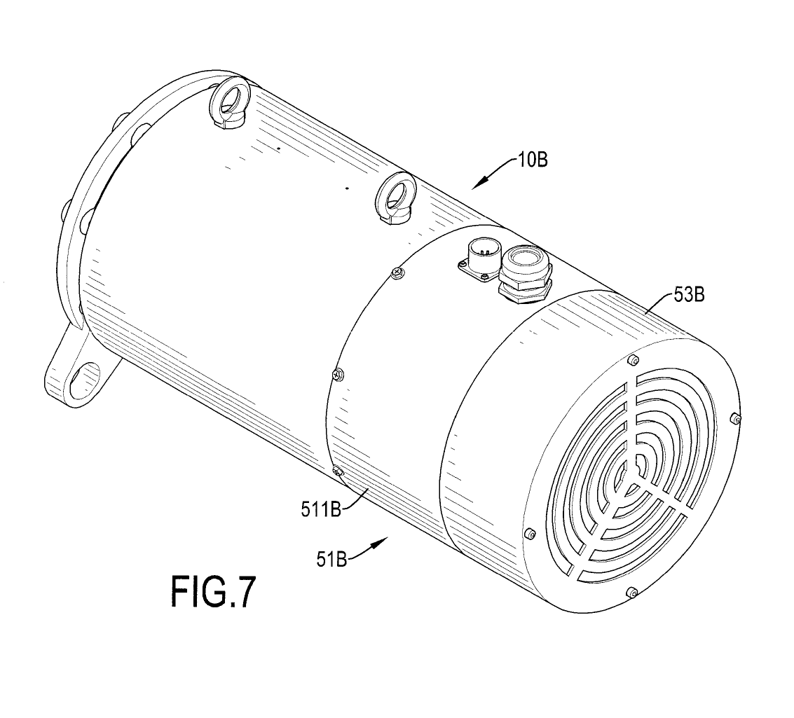

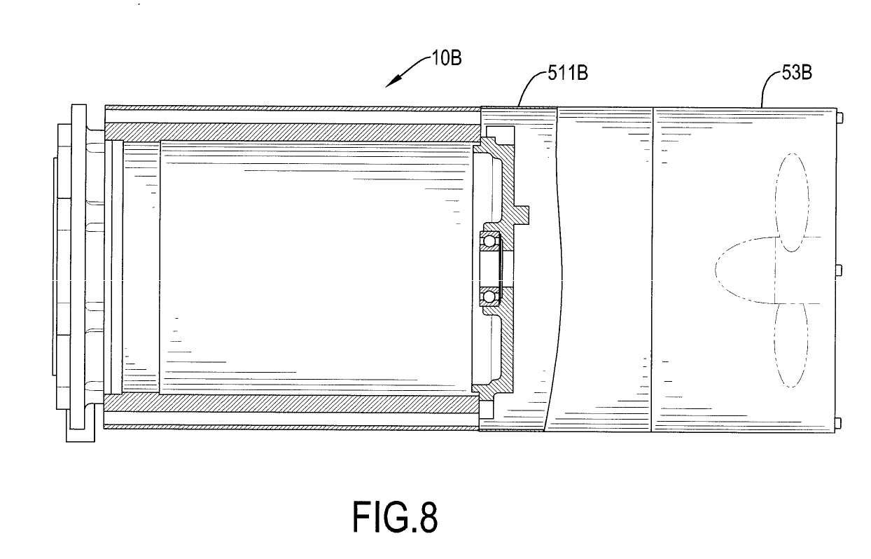

With reference to FIG. 6, the second embodiment of the motor housing in accordance with the present invention has a structure same as that of the first embodiment except that the shape of the stands 22A,32A on the front and rear caps 20A,30A. The front stand 22A is radially formed on and protrudes from the front panel 21 A of the front cap 20A and has a connecting end, a free end, a width and multiple front securing threaded holes 221A. The connecting end is connected to the front panel 21A. The free end is opposite to the front panel 21A. The width gradually decreases from the connecting end to the free end. The front securing threaded holes 221A are defined in the free end of the front stand 22A. The rear stand 32A is radially formed on and protrudes from the rear panel 31A of the rear cap 30A and has a connecting end, a free end, a width and multiple rear securing threaded holes 321A. The connecting end is connected to the rear panel 31A. The free end is opposite to the rear panel 31A. The width gradually decreases from the connecting end to the free end. The rear securing threaded holes 321A are defined in the free end of the rear stand 32A. The hood casing 511A has a notch 515A in which the rear stand 32A of the rear cap 30A is held. With reference to FIGS. 7 and 8, in the third embodiment, the air blower 53B is aligned with the heat-dissipating casing 10B and the hood casing 511B of the wind hood 51B, such that the air can be blown directly into the heat-dissipating casing 10B.

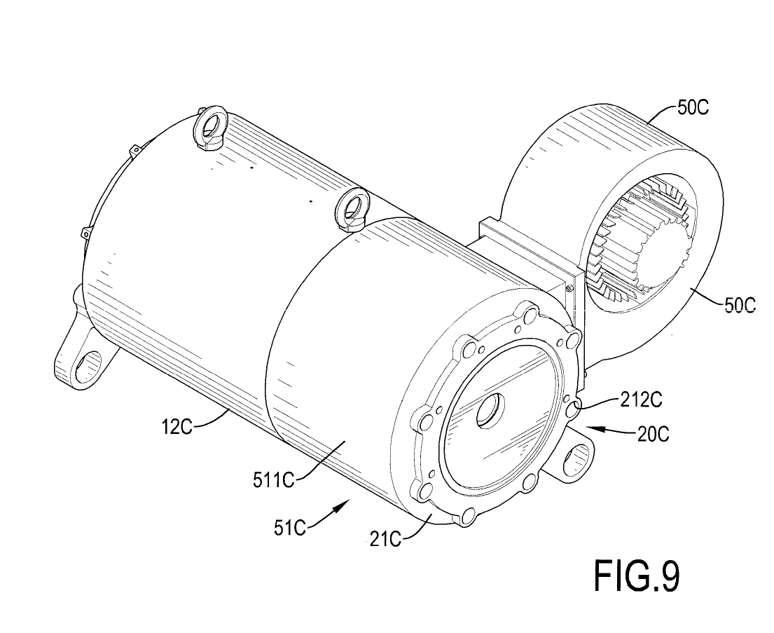

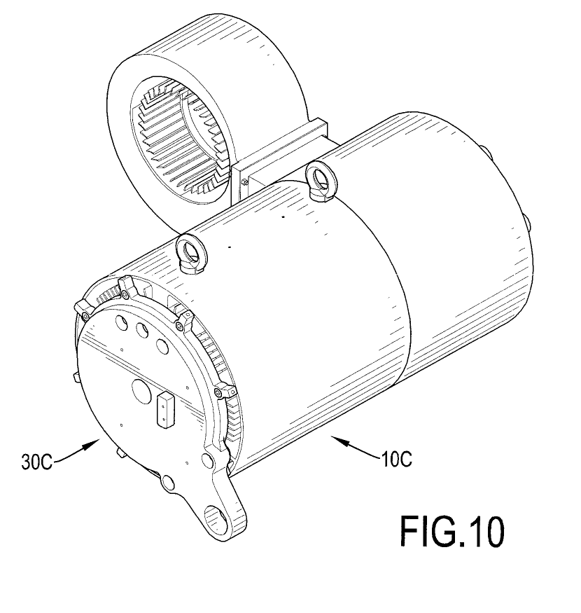

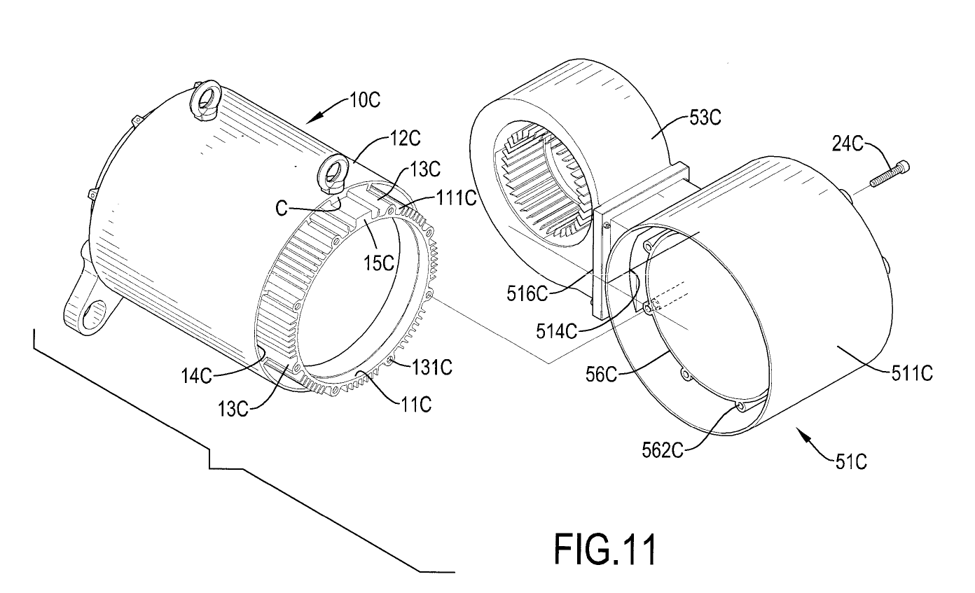

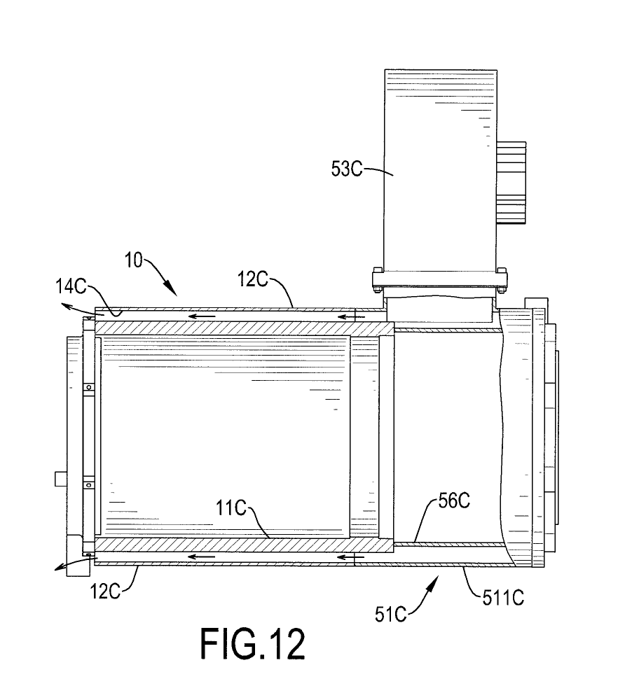

With reference to FIGS. 9 to 12. the fourth embodiment of the motor housing in accordance with the present invention comprises a heat-dissipating casing 10C, a front cap 20C, a rear cap 30C and a fan assembly 50C. The heat-dissipating casing 10C has an inner casing 11C and an outer casing 12C.

The outer casing 12C has a length shorter than that of the inner casing 11C to define a cutout C at the front end of the heat-dissipating casing 10C between the inner and outer casings 11C,12C to make the fins 111C and the baffle ribs 13C exposed from the cutout C.

The front cap 20C is circular, is connected securely to the front end of the heat-dissipating casing 10C and may have a structure substantially same as that in the first embodiment.

The rear cap 30C is circular, is attached securely to the rear end of the heat-dissipating casing 10C to close the rear open end of the inner casing 11C. The rear cap 30C may have a structure substantially same as that in the first embodiment, so the detail description of the front and rear caps 20C,30C is omitted.

The fan assembly 50C is mounted between the front end of the heat-dissipating casing 10C and the front cap 20C and comprises a wind hood 51C and an air blower 53C.

The wind hood 51C is connected securely between the front end of the heat-dissipating casing 10C and the front cap 20C and communicates with the air passages 14C in the heat-dissipating casing 10C. The wind wood 51C has a rear end mounted in the cutout C and around the front open end of the inner casing 11C and abutting with the front end of the outer casing 12C. The wind hood 51C comprises a tubular hood casing 511C. an inner connecting collar 56C and multiple collar through holes 562C.

The tubular hood casing 511C is mounted around the front open end of the inner casing 11C and has a rear end abutting with the front end of the outer casing 12C. The inner connecting collar 56C is co-axially formed in the hood casing 511C. The collar through holes 562C are defined through and around the inner connecting collar 56C and align respectively with the front threaded holes 131C in the baffle ribs 13C. The front fasteners 24C are respectively mounted through front through holes 212C in the front cap 20C and the collar through holes 562C and respectively screwed into the front threaded holes 131C to connect the wind hood 51C securely with the heat-dissipating casing 10C.

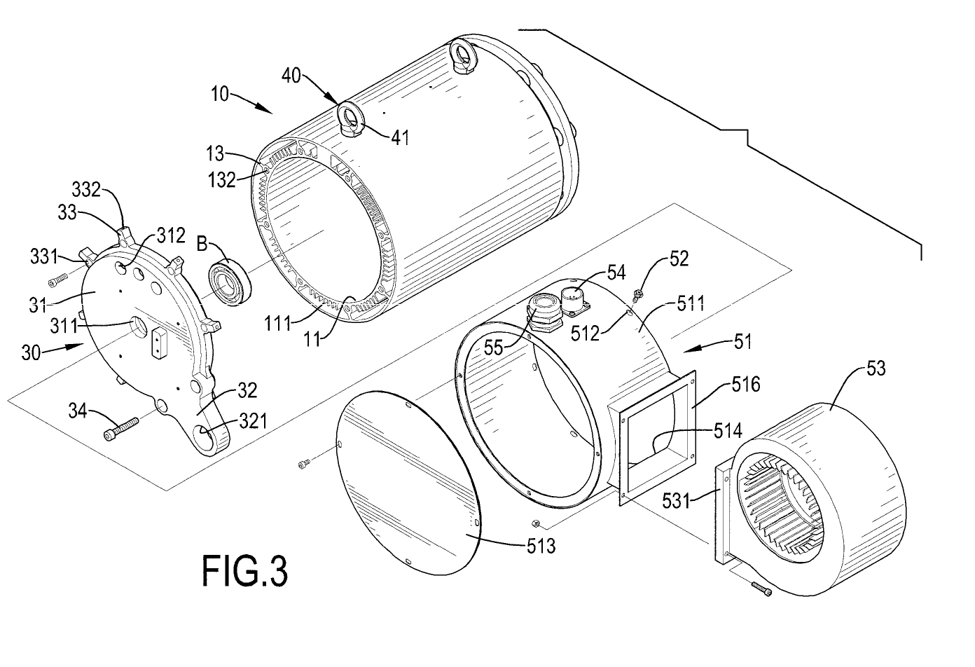

In addition, the hood casing 511C may further have a vent 514C, a fan connecting frame 516C and two wire tubes as the first embodiment shown in FIG. 3.

The air blower 53C is attached to the wind hood 51C and is preferably attached to the fan connecting frame 516C to blow air into the air passages 14C via the wind hood 51C.

The operation of the fourth embodiment is substantially same as that of the first embodiment, but the airflow blown by the air blower is from the front end to the rear end of the heat-dissipating casing 10C.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A motor housing comprising a heat-dissipating casing having:
a tubular outer casing having an inner surface; and
a tubular inner casing co-axially mounted in the outer casing and having
multiple fins formed on and protruding radially from an outer surface of the inner casing; and
multiple baffle ribs formed on and protruding radially from the outer surface of the inner casing and connected to the inner surface of the outer casing to form multiple air passages between the inner surface of the outer casing and the outer surface of the inner casing, wherein each baffle rib has two ends and a front threaded hole and a rear threaded hole defined respectively in the ends of the baffle rib.

2. The motor housing as claimed in claim 1 further comprising
a front cap attached securely to a front end of the heat-dissipating casing with multiple front fasteners mounted through the front cap and screwed respectively into the front threaded holes to close a front open end of the inner casing and having a front shaft hole defined through the front cap and a front bearing mounted in the front shaft hole;
a rear cap attached securely to a rear end of the heat-dissipating casing with multiple rear fasteners mounted through the rear cap and screwed respectively into the rear threaded holes to close a rear open end of the inner casing and having
a rear shaft hole defined through the rear cap;
a rear bearing mounted in the rear shaft hole; and
multiple wire holes defined through the rear cap; and
a fan assembly connected to the rear end of the heat-dissipating casing and comprising
a wind hood connected securely with the rear end of the heat-dissipating casing and communicating with the air passages in the heat-dissipating casing; and
an air blower attached to the wind hood to blow air into the air passages via the wind hood.

3. The motor housing as claimed in claim 2, wherein
the front cap is circular and has
a round front panel having a diameter equal to that of the outer casing, wherein the front shaft hole is defined centrally through the front panel;
an annular front connecting collar formed on the front panel at a side facing the heat-dissipating casing and abutting with the front open end of the inner casing and the baffle ribs at positions in where the front threaded holes are defined to space the front panel from the outer casing; and
multiple front through holes defined through the front panel and respectively aligning with the front threaded holes in the baffle ribs, wherein the front fasteners are mounted respectively through the front through holes in the front panel and respectively screwed into the front threaded holes in the baffle ribs; and
the rear cap is circular and has
a round rear panel having a diameter equal to that of the inner casing, wherein the rear shaft hole is defined centrally through the rear panel;
multiple rear connecting blocks formed on and radially protruding from a periphery of the rear panel, and each rear connecting block has a rear through hole defined through the rear connecting block and aligning with one of the rear threaded holes in the baffle ribs, wherein the rear fasteners are mounted respectively through the rear through holes in the rear connecting blocks and respectively screwed into the rear threaded holes in the baffle ribs; and
the wire holes are defined through the rear panel around the rear shaft hole at positions adjacent to the periphery of the rear panel.

4. The motor housing as claimed in claim 3, wherein
the front cap further has a front stand radially formed on and protruding from the front panel and having a front mounting hole defined through the front stand;
the rear cap further has a rear stand radially formed on and protruding from the rear panel and having a rear mounting hole defined through the rear stand;
the wind hood has a notch in which the rear stand of the rear cap is held; and
the heat-dissipating casing further has
a securing block formed on and radially protruding from the outer surface of the inner casing and connected to the inner surface of the outer casing;
multiple hanging holes defined in the outer casing at positions corresponding to the securing block; and
multiple hanging rings respectively connected securely to the hanging holes.

5. The motor housing as claimed in claim 4, wherein
each rear connecting block of the rear cap has a free end being flush with an outer surface of the outer casing and a hood connecting threaded hole defined in the free end of the rear connecting block;
the wind hood comprises:
a tubular hood casing mounted around the rear connecting blocks on the rear cap and having a front end abutting with a rear end of the outer casing, wherein the notch is defined in the front end of the hood casing;
multiple hood through holes defined through the hood casing and aligning respectively with the hood connecting threaded holes in the rear connecting blocks of the rear cap; and
multiple hood fasteners respectively mounted through the hood through holes and respectively screwed into the hood connecting threaded holes in the rear connecting blocks of the rear cap.

6. The motor housing as claimed in claim 5, wherein
the wind hood further comprises a rear cover attached to a rear end of the hood casing; and
the hood casing further has
a vent defined in the hood casing;
a fan connecting frame formed on and protruding from the hood casing around the vent and securely connected with the air blower; and
two wires tubes formed on and protruding from the hood casing.

7. The motor housing as claimed in claim 3, wherein
the front cap further has a front stand radially formed on and protruding from the front panel and having
a connecting end connected to the front panel;
a free end opposite to the front panel;
a width gradually decreasing from the connecting end to the free end; and
multiple front securing threaded holes defined in the free end of the front stand;
the rear cap further has a rear stand radially formed on and protruding from the rear panel and having
a connecting end connected to the rear panel;
a free end opposite to the rear panel;
a width gradually decreasing from the connecting end to the free end; and
multiple rear securing threaded holes defined in the free end of the rear stand; and
the wind hood has a notch in which the rear stand of the rear cap is held.

8. The motor housing as claimed in claim 7, wherein
each rear connecting block of the rear cap has a free end being flush with an outer surface of the outer casing and a hood connecting threaded hole defined in the free end of the rear connecting block;
the wind hood comprises:
a tubular hood casing mounted around the rear connecting blocks on the rear cap and having a front end abutting with a rear end of the outer casing, wherein the notch is defined in the front end of the hood casing;
multiple hood through holes defined through the hood casing and aligning respectively with the hood connecting threaded holes in the rear connecting blocks of the rear cap; and
multiple hood fasteners respectively mounted through the hood through holes and respectively screwed into the hood connecting threaded holes in the rear connecting blocks of the rear cap.

9. The motor housing as claimed in claim 8, wherein
the wind hood further comprises a rear cover attached to a rear end of the hood casing; and
the hood casing further has
a vent defined in the hood casing;
a fan connecting frame formed on and protruding from the hood casing around the vent and securely connected with the air blower; and
two wires tubes formed on and protruding from the hood casing.

10. The motor housing as claimed in claim 1 further comprising
a front cap connected securely to a front end of the heat-dissipating casing and having a front shaft hole defined through the front cap and a front bearing mounted in the front shaft hole;
a rear cap attached securely to a rear end of the heat-dissipating casing with multiple rear fasteners mounted through the rear cap and screwed respectively into the rear threaded holes to close a rear open end of the inner casing and having
a rear shaft hole defined through the rear cap;
a rear bearing mounted in the front shaft hole; and
multiple wire holes defined through the rear cap; and
a fan assembly mounted between the front end of the heat-dissipating casing and the front cap and comprising
a wind hood connected securely between the front end of the heat-dissipating casing and the front cap and communicating with the air passages in the heat-dissipating casing; and
an air blower attached to the wind hood to blow air into the air passages via the wind hood.

11. The motor housing as claimed in claim 10, wherein the outer casing has a length shorter than that of the inner casing to define a cutout at the front end of the heat-dissipating casing between the inner and outer casings to make the fins and the baffle ribs exposed from the cutout; and
the wind wood has a rear end mounted in the cutout and around the front open end of the inner casing and abutting with a front end of the outer casing.

12. The motor housing as claimed in claim 11, wherein the front cap is circular, is attached securely to the front end of the wind hood and has
a round front panel having a diameter equal to that of the outer casing, wherein the front shaft hole is defined centrally through the front panel;
an annular front connecting collar formed on the front panel at a side facing the heat-dissipating casing at a position corresponding to the front threaded holes; and
multiple front through holes defined through the front panel and respectively aligning with the front threaded holes in the baffle ribs; and
the rear cap is circular and has
a round rear panel having a diameter equal to that of the inner casing, wherein the rear shaft hole is defined centrally through the rear panel;
multiple rear connecting blocks formed on and radially protruding from a periphery of the rear panel, and each rear connecting block has a rear through hole defined through the rear connecting block and aligning with one of the rear threaded holes in the baffle ribs, wherein the rear fasteners are mounted respectively through the rear through holes in the rear connecting blocks and respectively screwed into the rear threaded holes in the baffle ribs; and
the wire holes are defined through the rear panel around the rear shaft hole at positions adjacent to the periphery of the rear panel.

13. The motor housing as claimed in claim 12, wherein
the front cap further has a front stand radially formed on and protruding from the front panel and having a front mounting hole defined through the front stand;
the rear cap further has a rear stand radially formed on and protruding from the rear panel and having a rear mounting hole defined through the rear stand;
the wind hood has a notch in which the front stand of the front cap is held; and
the heat-dissipating casing further has
a securing block formed on and radially protruding from the outer surface of the inner casing and conned ed to the inner surface of the outer casing;
multiple hanging holes defined in the outer casing at positions corresponding to the securing block; and
multiple hanging rings respectively connected securely to the hanging holes.

14. The motor housing as claimed in claim 13, wherein the wind hood comprises:
a tubular hood casing mounted around the front open end of the inner casing and having a rear end abutting with the front end of the outer casing;
an inner connecting collar co-axially formed in the hood casing;
multiple collar through holes defined through and around the inner connecting collar and aligning respectively with the front threaded holes in the baffle ribs; and
multiple front fasteners respectively mounted through the collar through holes and respectively screwed into the front threaded holes to connect the wind hood securely with the heat-dissipating casing.

15. The motor housing as claimed in claim 14, wherein the hood casing further has
a vent defined in the hood casing;
a fan connecting frame formed on and protruding from the hood casing around the vent and securely connected with the air blower; and
two wires tubes formed on and protruding from the hood casing.

16. The motor housing as claimed in claim 12, wherein
the front cap further has a front stand radially formed on and protruding from the front panel and having
a connecting end connected to the front panel;
a free end opposite to the front panel;
a width gradually decreasing from the connecting end to the free end; and
multiple front securing threaded holes defined in the free end of the front stand;
the rear cap further has a rear stand radially formed on and protruding from the rear panel and having
a connecting end connected to the rear panel;
a free end opposite to the rear panel;
a width gradually decreasing from the connecting end to the free end; and
multiple rear securing threaded holes defined in the free end of the rear stand; and
the wind hood has a notch in which the rear stand of the rear cap is held.

17. The motor housing as claimed in claim 16, wherein the wind hood comprises:
a tubular hood casing mounted around the front open end of the inner casing and having a rear end abutting with the front end of the outer casing;
an inner connecting collar co-axially formed in the hood casing;
multiple collar through holes defined through and around the inner connecting collar and aligning respectively with the front threaded holes in the baffle ribs; and
multiple front fasteners respectively mounted through the collar through holes and respectively screwed into the front threaded holes to connect the wind hood securely with the heat-dissipating casing.

18. The motor housing as claimed in claim 17, wherein the hood casing further has
a vent defined in the hood casing;
a fan connecting frame formed on and protruding from the hood casing around the vent and securely connected with the air blower; and
two wires tubes formed on and protruding from the hood casing.

19. The motor housing as claimed in claim 1, wherein the heat-dissipating casing further has
a securing block formed on and radially protruding from the outer surface of the inner casing and connected to the inner surface of the outer casing;
multiple hanging holes defined in the outer casing at positions corresponding to the securing block; and
multiple hanging rings respectively connected securely to the hanging holes.
